(19) United States
(12) Patent Application Publication
(10) Pub. No.: US 2014/0374431 A1
(43) Pub. Date: Dec. 25, 2014

(54) Balancing Weight for Vehicle Wheels

(71) Applicant: Wegmann automotive GmbH & Co. KG, Veitschochheim (DE)

(72) Inventors: Hans-Ulrich BÜRGEL, Roden (DE); Dietmar WAGENSCHEIN, Veitshochheim (DE)

(21) Appl. No.: 14/482,081

(22) Filed: Sep. 10, 2014

Related U.S. Application Data
(63) Continuation of application No. PCT/EP2013/055592, filed on Mar. 18, 2013.

(30) Foreign Application Priority Data
Mar. 20, 2012 (EP) 12160442.5
Jul. 13, 2012 (EP) 12176440.1
Oct. 17, 2012 (EP) 12188902.6

(51) Int. Cl. F16F 15/32

(52) U.S. Cl. CPC F16F 15/324
USPC 221/1; 301/5.21

(57) ABSTRACT

A balancing weight for vehicle wheels has a first face for fitting the balancing weight onto an inner peripheral surface of the wheel's rim and a second face opposite the first face. In order to improve the handling including the feeding of the balancing weights to a balancing machine each balancing weight comprises at least one guideway for a connecting means for stacking a plurality of such balancing weights.

### PRIORITY CLAIM

This application is a continuation of pending International Application No. PCT/EP2013/055592 filed on 18 Mar. 2013, which designates the United States and claims priority from (1) European Application No. 12160442.5 filed on March 20, 2012, (2) European Application No. 12176440.1 filed on Jul. 13, 2012, and (3) European Application No. 12188902.6 filed on Oct. 17, 2012, all of which are incorporated by reference in their entireties.

### BACKGROUND OF THE INVENTION

1. Field of the Invention

The invention relates to a balancing weight, an assembly of a plurality of such balancing weights and a process for feeding balancing weights to a balancing machine, all for use in association with the balancing of vehicle wheels.

2. Description of Relevant Art

The balancing of vehicle wheels is a well-known technique. Two kinds of balancing weights are in use. The first kind of balancing weights is fixed by a clamp, as disclosed in European patent EP 1 613 876 B1, while the second kind is fixed by means of a self-adhesive tape, as disclosed in U.S. Pat. No .6,364,421 B1.

Both kinds of balancing weights are commercially available in a plurality of sizes and shapes. When balancing a vehicle wheel, the proper balancing weight is selected and attached to the rim at the proper position, determined by a balancing machine, which may perform the complete balancing process.

Mostly, the balancing weights are supplied as bulk material in different sizes in boxes. The proper balancing weight is selected either by hand or in an automatic process by the balancing machine. Selecting the balancing weight by hand is prone to errors. Feeding an automatic balancing machine with bulk balancing weights requires an operator putting the correct size of the balancing weights in orderly fashion into the magazine of the balancing machine.

### SUMMARY OF THE INVENTION

The embodiments are based on the object of improving the foresaid handling of balancing weights.

A first embodiment relates to a balancing weight having a first face adapted to be fitted onto an inner peripheral surface of the rim and a second face opposing the first face, comprises at least one guideway for a connecting means for stacking a plurality of such balancing weights. Preferably, the guideway connects or forms a channel between the first face and the second face.

A plurality of the balancing weights are arranged in the same or identical orientation to form a stack and held together by the connecting means. Preferably, a first face of a first balancing weight is close to a second face of a second balancing weight.

Preferably, the connecting means is a cord. The term “cord” is to be understood in a broad sense, comprising into alia a braid, wire or band of suitable material like metal, natural or synthetic fibers. However, if the balancing weights have a single channel (e.g. a through-hole) with polygonal cross-section and therefore requiring a connecting means with a complementary cross-section in order to maintain alignment of the balancing weights in the stack, the connecting means preferably consists of a synthetic resin. Hence, a plurality of such balancing weights can easily be stacked, either manually or by a packing machine to form packs.

Preferably, the guideway is a traverse channel running from the first to the second face of the balancing weight. The term “channel” is to be understood in a broad sense, including but not limited to a hole or a notch, having a circular or non-circular cross-section. For instance, the balancing weight may have an open notch in its narrow side and preferably a further notch in its opposite narrow side for receiving the connecting means, made from a material and with a cross-section such that it secures a plurality of such balancing weights to form a sufficiently stable stack.

Specifically, if the balancing weight has a single channel, such channel preferably has a polygonal cross-section for receiving the connecting means, the latter having a complementary cross-section, such that the balancing weights are kept together in the stack in an oriented manner.

In addition or alternatively, the first and the second face may have complementary profiles for aligning subsequent balancing weights in the stack. For example, the first face of the balancing weight may have one or more indentations and the second face may have one or more complementary projections.

In a preferred embodiment, the balancing weight has at least two spaced apart channels.

The channel, respectively each channel can simply be a through-hole. Such hole may be formed in a molding process of the balancing weight. Alternatively, the through-hole may be punched or drilled.

The balancing weight may form a stable stack, if each balancing weight has at least two through-holes, provided lengthwise an axis of symmetry of the balancing weight, which usually has an elongated contour or shape.

In a preferred embodiment, the balancing weight has at least one notch, running perpendicular to a lengthwise axis of the balancing weight. The cross section and the depth of the notch (or each notch) depend on its purpose: The notch or notches may either serve to ease the bending of the balancing weight in one or two axis in order to better conform to the curvature of the rim. Alternatively or additionally, the notch (or notches) may define a predetermined breaking line, permitting to sever one or both its end-sections from the remainder of the balancing weight in case a balancing weight of lesser mass than that of the original balancing weight is required.

The embodiments are not limited to a certain type of material or construction of a balancing weight. In a preferred embodiment, it consists of metal, usually zinc, having a mono-layer or multi-layer coating, comprising a self-adhesive face, which will then constitute the first face that is to say the face for fitting the balancing weight onto the rim, the self-adhesive face being protected by a tear-off liner.

In a preferred embodiment of the assembly of balancing weights having two spaced apart channels, the connecting means runs from last or uppermost balancing weight through the respective first channels of all balancing weights to the lowermost or first balancing weight and back in the opposite direction to the respective second channels. This simplifies the building of the stack.

In a further embodiment of the assembly the connecting means has a first end- section and a second end-section, both protruding at the same side of the stack and being sealed together close to the last or uppermost balancing weight. This simplifies the handling, specifically the storage and the transport of the stacks or packs.

According to another embodiment, the seal and/or the connecting cord may be color encoded. Different colors may represent different weights. The storage bin of a pick and place machine or dispenser for balancing weights may have the same color encoding to simplify allocation. Furthermore, there may be an information tag or banner attached to the connecting cord and/or seal. It may bear information about the weight of the balancing weights and/or may be color encoded as described above.

A further embodiment relates to a method for feeding balancing weights to a balancing machine, preferably an automatic balancing machine, wherein the balancing weights being configured to forms stacks, and the balancing machine being configured to receive these stacks. This process contributes to a further automation of the balancing of vehicle wheels.

### BRIEF DESCRIPTION OF THE DRAWINGS

In the following, the invention will be described by way of example, without limitation of the general inventive concept, on examples of embodiment and with reference to the drawings.

FIG. 1 is a perspective view of a stack comprising a plurality of balancing weights connected by a cord or wire.

FIG. 2 is a perspective view of a preferred balancing weight and a segment of the cord or wire for connecting a plurality of balancing weights.

FIG. 3 is a perspective view of another balancing weight and a segment of the cord or wire for connecting a plurality of balancing weights.

FIG. 4 is a perspective view of another balancing weight and a segment of the cord or wire for connecting a plurality of balancing weights.

FIG. 5 is a perspective view of another balancing weight and a segment of the cord or wire for connecting a plurality of balancing weights.

FIG. 6 is a perspective view of another balancing weight and a segment of the cord or wire for connecting a plurality of balancing weights.

FIG. 7 is a perspective view of another balancing weight and a segment of the cord or wire for connecting a plurality of balancing weights.

FIG. 8 is a perspective view of a stack comprising a plurality of clip-on balancing weights connected by a cord or wire.

FIG. 9 is a perspective view of a single clip-on balancing weight.

FIG. 10 is a perspective view of a stack comprising a plurality of clip-on balancing weights with integrated clips connected by a cord or wire.

FIG. 11 is a perspective view of a single clip-on balancing weight with integrated clip.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Generally, the illustrated balancing weights are in the shape of elongated parallelepipeds of metal or artificial resin. However, the invention is not limited to balancing weights of parallelepiped form but applies to other shapes, too, no matter whether they are designed for fixing by a clip or by means of a self-adhesive tape.

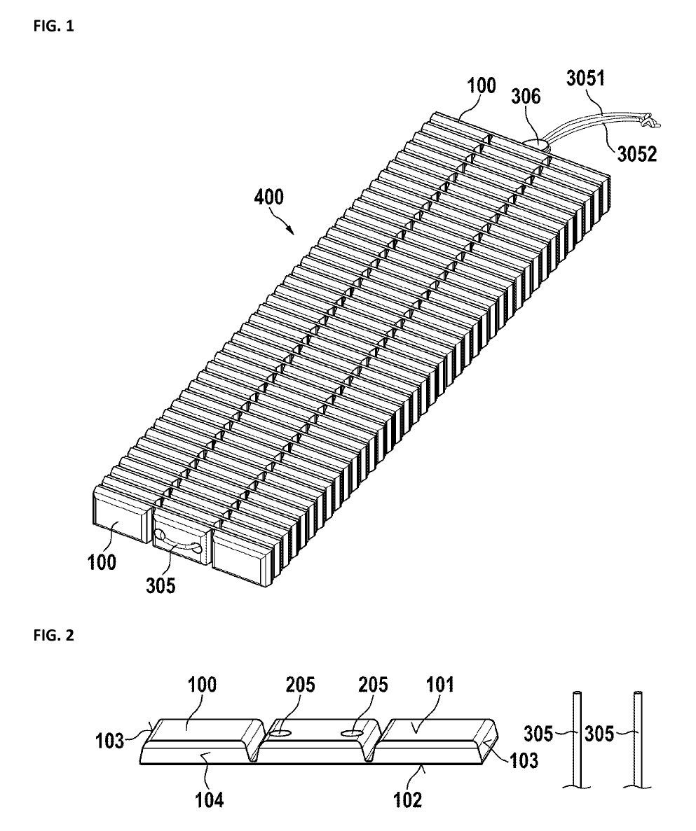

FIG. 1 illustrates a stack 400 comprising a large number of balancing weights 100, held together by a double ended connecting cord 305, running through respective spaced apart through-holes in the balancing weights. The connecting cord 305 has a first end-section 3051 and a second end-section 3052, protruding from the last balancing weight. Close to the last balancing weight, the two end-sections are held together by a seal 306, such that the stack 400 has sufficient stability, specifically for storage and/or handling by a conveyor, which may feed the stack to a magazine of a balancing machine (not shown). The seal and/or the connecting cord may be color encoded. Different colors may represent different weights and or different numbers of weights. The storage bin of a pick and place machine or dispenser for balancing weights may have the same color encoding to simplify allocation. Furthermore, there may be an information tag or banner attached to the connecting cord and/or seal. It may bear information about the weight and/or number of the balancing weights and/or may be color encoded as described above.

The balancing weight 100 in FIG. 2 and those in the further figures all have a first face 102 for fitting the balancing weight onto an inner peripheral surface of the rim of a vehicle wheel (not shown), and opposite the first face 102 a second face 101. Further, the balancing weight has two opposing short narrow sides 103 and two opposing long narrow sides 104.

Preferably, the balancing weight has two spaced apart guideways in the form of cylindrical through-holes 205 for receiving a connecting cord or rod 305. The balancing weight shown herein has three segments, which are separated by notches, or grooves, which simplify bending and adapting of the balancing weight to the radius of the rim. This embodiment is not limited to three segments as shown herein. It may have any number of segments including one. All other embodiments of balancing weights shown herein may also comprise segments.

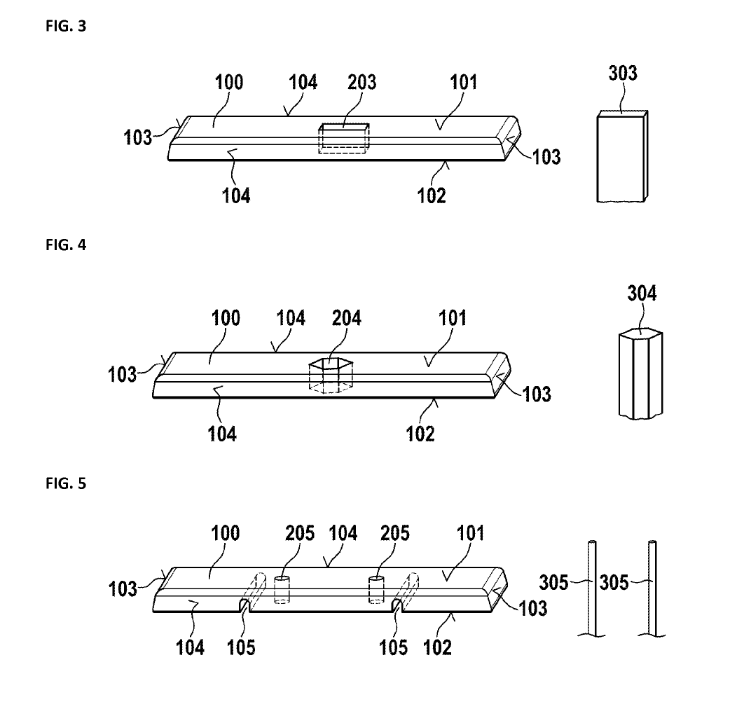

In FIG. 3, the balancing weight has a single guideway in the form of an oblong through-hole 203, designed for receiving a connecting band 303, which may be much thinner than the width of the oblong through-hole 203. Generally, in the case of a single guideway, the connecting cord has a first end at a first side of the stack and a second end at the second side of the stack. There may be a terminator at at least one end of the cord to prevent the cord from slipping through the holes. Such a terminator may be a knot or a plastic or metal part, which has a size larger than the size or diameter of the holes. There may also be a terminator on the first side and a seal at the second side, or seals at both sides.

In FIG. 4, the balancing weight has a guideway in the form of a hexagonal through-hole 204 for receiving a connecting wire or rod 304 with corresponding hexagonal cross-section.

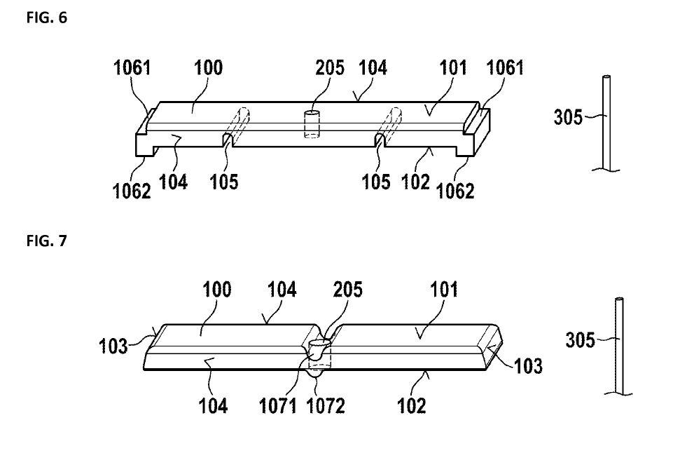

In FIG. 5, the balancing weight has two spaced apart guideways in the form of cylindrical through-holes 205, each for receiving a connecting cord 305. The cord 305 may consist of a flexible material. Alternatively, it may be a solid or braided metal wire. In this embodiment the balancing weight also has two spaced apart notches 105 in the lower or first face, the notches 105 running perpendicular to a lengthwise axis of the balancing weight and enabling easy bending of the balancing weight in order to better conform to the contour of the rim, alternatively for defining a predetermine break line, for severing one or both its end-sections form the center part of the balancing weight.

Whereas in the embodiments in FIGS. 1 to 5 the cross-section of the guideway in cooperation with the cross-section of the respective connecting means warrants the proper alignment of the balancing weights in the stack, FIGS. 6 and 7 illustrate embodiments warranting the alignment of the balancing weight in the stack by the shape of the balancing weight its self, i.e. by providing its first and its second face with mating indentations and protrusions, respectively.

In FIG. 6, the balancing weight has a single central cylindrical through-hole 205 for a connecting cord 305 and opposing stepped short upper edges 1061 and opposing complementary protruding short lower edges 1062, such that the stepped short upper edges 1061 will receive the protruding short lower edges 1062 of the adjacent above balancing weight (not shown). The balancing weight has the same type of traverse notches 105 as shown in FIG. 6.

In FIG. 7, the balancing weight also has a single central through-hole 205 for a connecting cord 305. Proper alignment of adjacent balancing weights is warranted by a traverse groove 1071 in the first face and a complementary traverse bulge 1072 in the second face.

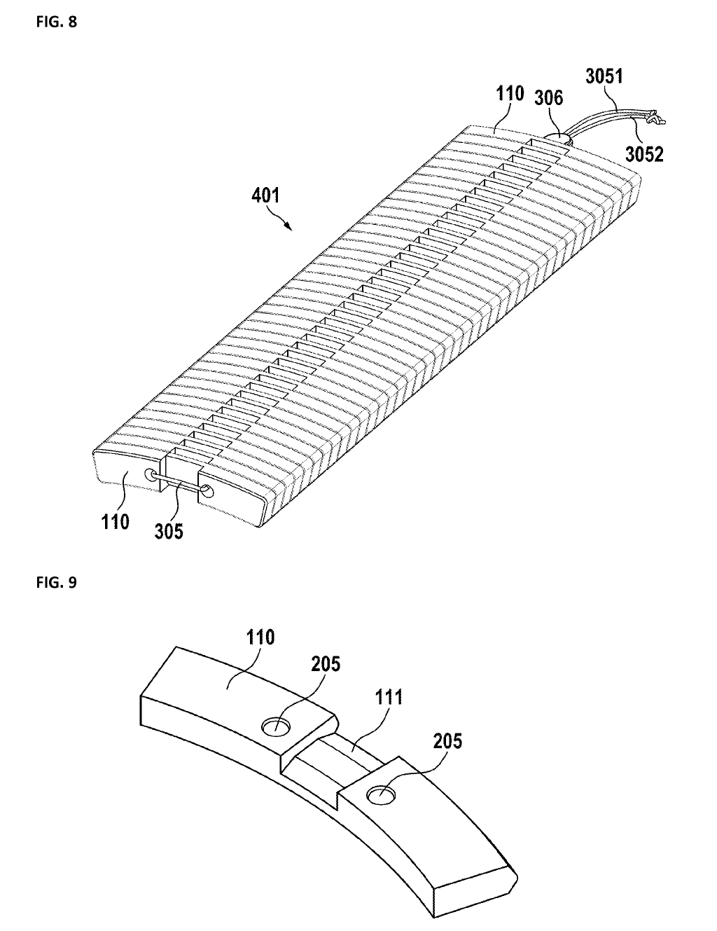

In FIG. 8, an alternate stack 401 comprising a number of clip-on balancing weights 110, held together by a double ended connecting cord 305, is shown. This is similar to FIG. 1, except for the different balancing weights.

In FIG. 9, a clip-on balancing weight 110, as used in the stack in the previous figure is shown, having through holes 205. There may be a clip attachment surface 111 to which a clip (not shown) for holding the balancing weight to a wheel may interface.

In FIG. 10, a further stack 402 comprising a number of clip-on balancing weights with integrated clip 120, held together by a double ended connecting cord 305, is shown. This is similar to FIG. 1, except for the different balancing weights.

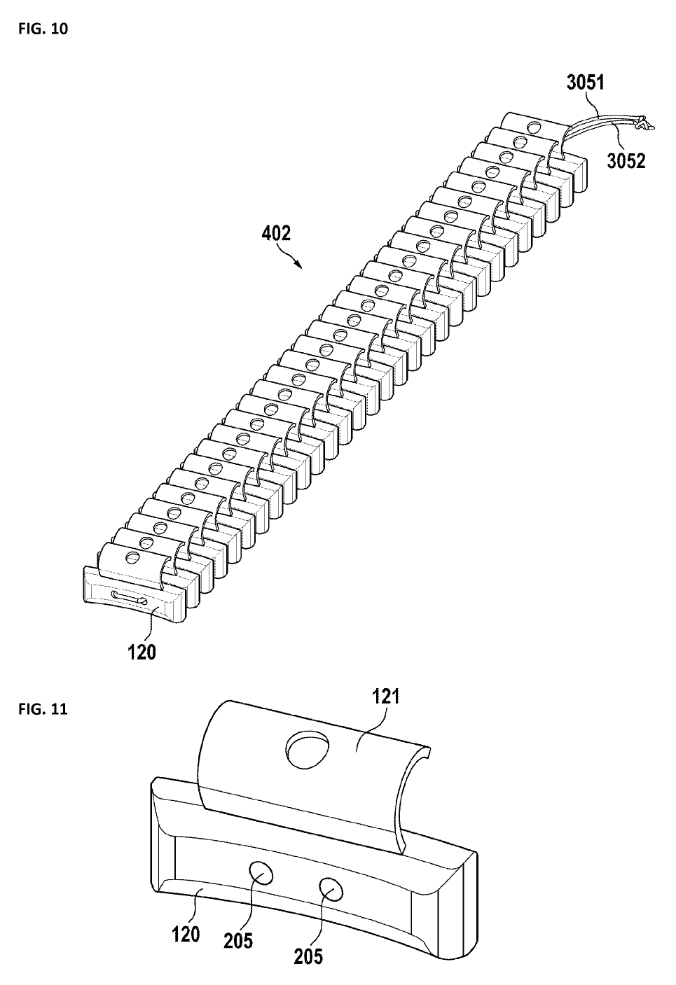

In FIG. 11, a clip-on balancing weight 120 with a clip 121, as used in the stack in the previous figure is shown, having through holes 205.

It will be appreciated to those skilled in the art having the benefit of this disclosure that this invention is believed to provide balancing weights for vehicles. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### List of Reference Numerals

100 balancing weight

101 second face

102 first face

103 short narrow side

104 long narrow side

105 notch

110 clip-on balancing weight

111 clip attachment surface

120 balancing weight with clip

121 clip

1061 stepped short upper edge

1062 protruding short lower edge

1071 groove

1072 bulge

203 oblong through-hole

204 hexagonal through-hole

205 cylindrical through-hole

303 connecting band

304 connecting rod with hexagonal cross-section

305 connecting cord

3051 first end-section

3052 second end-section

306 seal

400 stack

401 alternate stack

402 further stack

1. Assembly comprising:
a plurality of balancing weights for vehicle wheels,
the balancing weights each having a first face for fitting the balancing weight onto an inner peripheral surface of the rim of a vehicle wheel, and a second face opposing the first face,
the balancing weights each comprise at least one guideway between the first face and the second face configured to receive a cord or wire through the balancing weight, and the balancing weights are arranged in the same orientation and held together by the cord or wire to form a stack.

2. Assembly according to claim 1, wherein the balancing weights each have two spaced apart channels, wherein the cord or wire runs from a last or uppermost balancing weight, through a first channel of each balancing weight to the lowermost or first balancing weight, and back in the opposite direction through a second channel of each balancing weight.

3. Assembly according to claim 1, wherein the cord or wire has a first end-section and a second end-section, and both of the first and second end-sections protrude at the same side of the stack and are coupled together adjacent to a last or uppermost balancing weight.

4. Assembly according to claim 1, wherein the cord or wire and/or a seal coupled to the cord or wire are color coded, wherein a color of the color coding represents a specific weight of the balancing weights.

5. Assembly comprising:
a plurality of balancing weights for vehicle wheels,
the balancing weights each having a first face for fitting the balancing weight onto an inner peripheral surface of the rim of a wheel, and a second face opposing the first face,
the balancing weights each comprise at least one guideway between the first face and the second face configured to receive a connecting means for stacking the balancing weights, and
the balancing weights are arranged in identical orientation and held together by the connecting means to form a stack,
the balancing weights each have two spaced apart channels,
wherein the connecting means has a first end-section and a second end-section, and both of the first and second end-sections protrude at the same side of the stack and are coupled together adjacent to a last or uppermost balancing weight.

6. Assembly according to claim 5, wherein the connecting means comprises a cord or wire.

7. Assembly according to claim 5, wherein the connecting means and/or a seal are color coded, wherein a color of the color coding represents a specific weight of the balancing weights.

8. Method for feeding balancing weights to a balancing machine, the method comprising:
inserting an assembly of claim 1 into a balancing machine that is configured to receive said assemblies.

9. Method for feeding balancing weights to a balancing machine, the method comprising:
Inserting an assembly of claim 5 into a balancing machine that is configured to receive said assemblies.
